(19) United States
(12) Patent Application Publication
(10) Pub. No.: US 2018/0339451 A1
(43) Pub. Date: Nov. 29, 2018

(54) NOZZLE FOR THREE-DIMENSIONAL (3D) PRINTER INCLUDING ECCENTRIC DISCHARGE PORT AND 3D PRINTER INCLUDING NOZZLE

(71) Applicant: KOREA INSTITUTE OF SCIENCE AND TECHNOLOGY, Seoul (KR)

(72) Inventors: Myoung-Woon Moon, Seoul (KR); Wonjin Jo, Seoul (KR); O Chang Kwon, Seoul (KR)

(73) Assignee: KOREA INSTITUTE OF SCIENCE AND TECHNOLOGY, Seoul (KR)

(21) Appl. No.: 15/987,171

(22) Filed: May 23, 2018

(30) Foreign Application Priority Data
May 25, 2017 (KR) 10-2017-0064888
Apr. 25, 2018 (KR) 10-2018-0048019

(51) Int. Cl. B29C 64/209; B33Y 30/00; B29C 64/227; B22F 3/00; B29C 64/245

(52) U.S. Cl. CPC B29C 64/209; B33Y 30/00; B29K 2101/12; B22F 3/008; B29C 64/245; B29C 64/227

(57) ABSTRACT

Provided are a nozzle for a three-dimensional (3D) printer to extrude a 3D printing material, wherein the nozzle includes a discharge port in a bottom surface of the nozzle and configured to extrude the 3D printing material, and the discharge port is eccentrically located with respect to a center of the bottom surface; and a 3D printer including a nozzle unit including the nozzle.

### CROSS-REFERENCE TO RELATED APPLICATION

This application claims the benefit of Korean Patent Application No. 10-2017-0064888, filed on May 25, 2017, and 10-2018-0048019, filed on Apr. 25, 2018, in the Korean Intellectual Property Office, the disclosure of which is incorporated herein in its entirety by reference.

### BACKGROUND

### 1. Field

One or more embodiments relate to a nozzle for a three-dimensional (3D) printer and a 3D printer including the nozzle, wherein the nozzle includes an eccentric discharge port.

### 2. Description of the Related Art

Three-dimensional (3D) printing refers to an additive manufacturing process that produces a desired shape through a process of stacking materials on the basis of 3D digital data obtained by, for example, scanning or modeling. It is known that 3D printing can save about 50 percent (%) or more of the energy required for manufacturing and reduce materials by more than 90%, compared to other processes.

3D printing is classified into 9 categories depending on the stacking method. Among these 9 categories, the material extrusion (ME) system is the simplest in terms of its hardware configuration, and thus a shape can be made directly even if the user is not an expert. Thus, 3D printers using the ME system are popular for home use. Among 3D printers using the ME system, 3D printers using thermoplastic resins, namely, 3D printers using fused filament fabrication (FFF) and fused deposition modeling (FDM), have become the most popular 3D printers, and these 3D printers mainly use filament-type plastic materials. These 3D printers dissolve a filament-type plastic material having a diameter of 1.75 millimeters (mm) or 3 mm, and discharge the filament-type plastic material through a nozzle.

Generally, in 3D printing such as 3D printing using the ME system, an output is produced by sequentially laminating materials. At this time, linear outputs constituting one layer are continuously printed to form an overall output. However, when using such linear outputs, it is difficult to enhance a strain rate or enlarge a surface area of the output due to limitations of physical properties of the materials. In order to enhance the strain rate of the output, a separate printing structure may be designed; however, this not only requires a separate design process, but also has limits in the realization of a complex shape with a combined structure consisting of a series of straight lines in a printing process.

Therefore, there is a great need for a novel 3D printing system that may increase a surface area and a strain rate of an output.

### SUMMARY

One or more embodiments include a nozzle for a three-dimensional (3D) printer that may output a meandering structure through a discharge port eccentrically located with respect to a center of a bottom surface of the nozzle.

One or more embodiments include a 3D printer that may increase a strain rate and a surface area of an output by employing the nozzle without a particular modification and with a relatively low cost.

Additional aspects will be set forth in part in the description which follows and, in part, will be apparent from the description, or may be learned by practice of the presented embodiments.

According to one or more embodiments, a nozzle for a three-dimensional (3D) printer to extrude a 3D printing material may include:

a discharge port in a bottom surface of the nozzle and configured to extrude the 3D printing material, the discharge port being eccentrically located with respect to a center of the bottom surface.

According to one or more embodiments, the discharge port may be located within a radius in a range of about 1 micrometer (μm) to about 100 centimeters (cm) from the center of the bottom surface.

According to one or more embodiments, a diameter of the discharge port may be in a range of about 10 percent (%) to about 30% of a diameter of the nozzle.

According to one or more embodiments, the discharge port may have a circular shape, an oval shape, or a polygonal shape.

According to one or more embodiments, the bottom surface may have a circular shape, an oval shape, or a polygonal shape.

According to one or more embodiments, the 3D printing material may include at least one selected from a thermoplastic polymer, a metal, a composite material, and an eco-friendly material.

According to one or more embodiments, the thermoplastic polymer may be selected from polylactic acid (PLA), acrylonitrile-butadiene-styrene (ABS) resin, nylon, and polyvinyl alcohol.

According to one or more embodiments, the nozzle may further include a flow path through which the 3D printing material may pass, wherein the flow path may be connected to the discharge port located in the bottom surface.

According to one or more embodiments, the flow path may have a cylindrical shape; a tub shape of which a vertical cross-section of a rotational axis may be polygonal; or a polyhedral shape.

According to one or more embodiments, the flow path may be connected to the discharge port in a direction perpendicular to the bottom surface.

According to one or more embodiments, the flow path may be connected to the discharge port in a direction that is not perpendicular to the bottom surface.

According to one or more embodiments, the flow path may include at least one bent portion, or may not include a bent portion.

According to one or more embodiments, a 3D printer may include:

at least one nozzle unit including the nozzle described above;

a nozzle-shifting unit configured to shift the at least one nozzle unit in all directions; and

an output area under the at least one nozzle unit and on which the 3D printing material extruded from the nozzle may be stacked and an output may be formed.

According to one or more embodiments, a speed ratio (Vₜ/Vₚ) of a feeding speed (Vₜ) over a printing speed (Vₚ) may be in a range of about 0.1 to about 10, wherein Vₚ may be a speed required for forming the output, and Vₜ may be a speed at which the 3D printing material is extruded from the nozzle.

According to one or more embodiments, the output area may include a substrate including at least one material selected from paper, wood, metal, and polymer.

According to one or more embodiments, the 3D printer may further include a driving unit for displacing the output area vertically.

According to one or more embodiments, the 3D printer may use fused filament fabrication (FFF), fused deposition modeling (FDM), or material extrusion(ME).

According to one or more embodiments, the output formed on the output area may include at least one curled area.

According to one or more embodiments, the output formed on the output area may include at least one pattern selected from a straight pattern, a wavy pattern, an alternating pattern, a coiling pattern, an overlapping pattern, and a braided pattern.

According to one or more embodiments, the output formed on the output area may have a multilayer structure formed by stacking at least two layers of the 3D printing material.

According to one or more embodiments, the multilayer structure may be:

i) a structure in which a layer including at least one curled area may be stacked, or

ii) a structure in which a layer including at least one curled area and a layer not including a curled area may be stacked in a random sequence.

According to one or more embodiments, a 3D printer for four-dimensional (4D) printing technology may include:

a first nozzle unit and a second nozzle unit, each including a nozzle for a 3D printer;

a nozzle-shifting unit configured to shift the first nozzle unit and the second nozzle unit in all directions; and

an output area under the first nozzle unit and the second nozzle unit and on which a 3D printing material extruded from each of the nozzles of the first nozzle unit and the second nozzle unit is stacked, respectively, and an output is formed, wherein at least one of the first nozzle unit and the second nozzle unit may include the nozzle described above.

According to one or more embodiments, i) at least one of the first nozzle unit and the second nozzle unit may further include a centric discharge port, or ii) the first nozzle unit and the second nozzle unit may each further include an eccentric discharge port.

### BRIEF DESCRIPTION OF THE DRAWINGS

These and/or other aspects will become apparent and more readily appreciated from the following description of the embodiments, taken in conjunction with the accompanying drawings in which:

FIG. 1A is a schematic view of a centric discharge port nozzle of the related art;

FIG. 1B is a schematic view of an embodiment of an eccentric discharge port nozzle;

FIG. 2 is a schematic view of another embodiment of an eccentric discharge port nozzle;

FIG. 3 shows images of meandering outputs formed by using an eccentric discharge port nozzle according to one or more embodiments according to a speed ratio Vₜ/Vₚ, the outputs being different from a linear output formed by using a centric discharge port nozzle of the related art;

FIG. 4 shows images of various patterns that may be included in outputs formed by using an eccentric discharge port nozzle according to one or more embodiments by controlling process parameters;

FIG. 5 shows graphs of deformation results of a tensile strength test performed on an output formed by using a centric discharge port nozzle of the related art and on an output formed by using an eccentric discharge port nozzle according to one or more embodiments;

FIG. 6A shows images of cross-sections of outputs of S-S structure;

FIG. 6B shows images of cross-sections of outputs of S-C structure which was implemented by using various pattern combinations;

FIG. 6C shows images of cross-sections of outputs of C-C structure which was implemented by using various pattern combinations;

FIG. 7 is a graph of strain rates of outputs having a monolayer structure and strain rates of the outputs of multilayer structures in FIG. 6;

FIG. 8A shows images of the results of deformation behavior of the outputs of S-S structure which were implemented by using a centric discharge port nozzle of the related art;

FIG. 8B shows images of the results of deformation behavior of the outputs of S-C structure which were implemented by using an eccentric discharge port nozzle according to an embodiment;

FIG. 9A shows images of a 3D output implemented by using a centric discharge port nozzle of the related art; and

FIG. 9B shows images of a 3D output implemented by using an eccentric discharge port nozzle according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

The following detailed description of the present disclosure refers to the accompanying drawings, which illustrate, by way of example, embodiments in which the present disclosure may be practiced. These embodiments are described in sufficient detail to enable those skilled in the art to practice the present disclosure. It should be understood that various embodiments of the present disclosure are different, but need not be mutually exclusive. For example, a particular shape, structure, and characteristics described herein in connection with an embodiment may be embodied in different embodiments without departing from the spirit and scope of the present disclosure. It is also to be understood that the position or arrangement of individual components within each disclosed embodiment may be varied without departing from the spirit and scope of the present disclosure. The following detailed description is, therefore, not to be taken in a limiting sense, and the scope of the present disclosure is to be limited only by the appended claims, along with the full scope of equivalents to which the claims are entitled, if properly explained. In the drawings, like reference numerals refer to the same or similar functions.

Hereinafter, with reference to the attached drawings, a nozzle for a three-dimensional (3D) printer and a 3D printer including the nozzle according to an embodiment will be further described.

According to an aspect of the present disclosure, a nozzle for a 3D printer may be configured to extrude a 3D printing material, the nozzle including a discharge port in a bottom surface of the nozzle and configured to extrude the 3D printing material, and the discharge port being eccentrically located with respect to a center of the bottom surface.

The term ‘being eccentrically located’ as used herein refers to being located outside the center of a specific area, however, a degree of deviation from the center is not particularly limited. The term ‘eccentric discharge port’ as used herein refers to a discharge port that is eccentric with respect to the center of a bottom surface of a nozzle, and the term ‘eccentric discharge port nozzle’ as used herein refers to a nozzle including the eccentric discharge port.

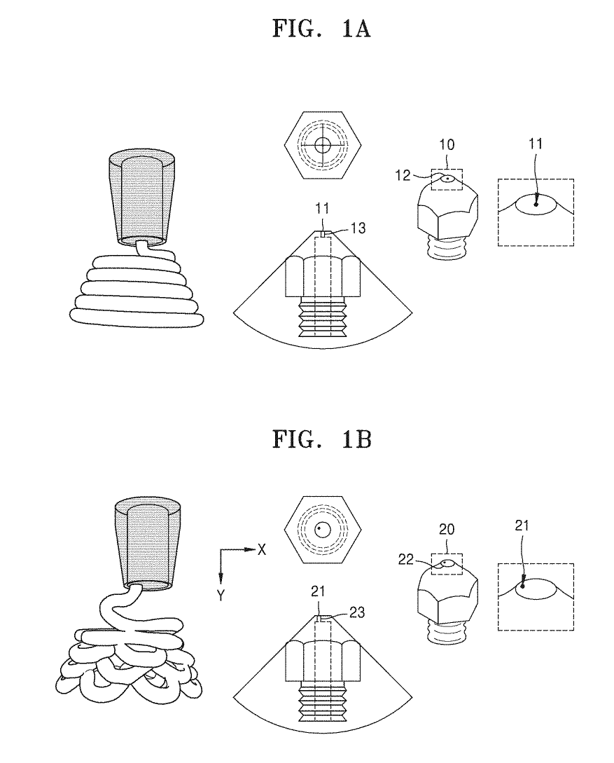

FIG. 1A is a schematic view of a centric discharge port nozzle of the related art. FIG. 1B is a schematic view of an embodiment of an eccentric discharge port nozzle. In particular, FIG. 1A is a schematic view of a centric discharge port nozzle of the related art and a layered form of a 3D printing material discharged from the centric discharge port nozzle of the related art, and FIG. 1B is a schematic view of an embodiment of an eccentric discharge port nozzle and a layered form of a 3D printing material discharged from the eccentric discharge port nozzle. In a centric discharge port nozzle 10 of the related art, a discharge port 11 may be located in the center of a bottom surface 12 of the nozzle, whereas, in an eccentric discharge port nozzle 20 according to an embodiment, a discharge port 21 may be eccentrically located with respect to the center of a bottom surface 22 of the nozzle.

As shown in FIGS. 1A and 1 B, when the centric discharge port nozzle 10 of the related art is used, the layered form of the 3D printing material is almost linear, whereas, when the eccentric discharge port nozzle 20 according to an embodiment is used, the layered form of the 3D printing material may be in a meandering form, which may result in an increase in a strain rate of the output.

As the nozzle according to an embodiment includes an eccentric discharge port, the melted 3D printing material may flow irregularly, that is, a phenomenon in which the flow becomes faster in a portion near the discharge port than in a distant portion may occur. Thus, due to this difference in the discharge speed of the 3D printing material, an extrusion defect may occur. In particular, the irregular flow may cause an eccentric extrusion curvature and irregular local deformation. Thus, the 3D printing material may be discharged in a meandering form through the eccentric discharge port nozzle.

In some embodiments, the discharge port may be located within a radius in a range of about 1 micrometer (μm) to about 100 centimeters (cm) from the center of the bottom surface of the nozzle. According to one or more embodiments, the discharge port may be located within a radius in a range of about 1 μm to about 1,000 cm from the center of the bottom surface of the nozzle. In some embodiments, when a 3D printer including the discharge port is used to print a large structure, the discharge port may be located within a radius in a range of about 1 cm to about 100 cm from the center of the bottom surface of the nozzle. Outside of these ranges, when the discharge port is located within a radius less than 1 μm from the center of the bottom surface, a degree of decentration of the discharge port is generally low, and thus it may be difficult to achieve a desired strain rate.

According to one or more embodiments, a diameter of the discharge port may be in a range of about 10 percent (%) to about 30% of a diameter of the nozzle for a 3D printer. Outside of this range, when a diameter of the discharge port is less than 10% of a diameter of the nozzle, clogging may often occur in the discharge port, and an output time may become excessively long when an output having an identical size is printed. On the other hand, when a diameter of the discharge port is greater than 30% of a diameter of the nozzle, it is difficult to control a meandering structure, and an output may be printed as a linear structure.

For example, the discharge port may have a diameter in a range of about 100 μm to about 400 μm. However, the diameter of the discharge port is not limited thereto. When a structure of the 3D printer is enlarged, the upper limit of the diameter of the discharge port may also be increased accordingly.

According to one or more embodiments, the discharge port may have a circular shape, an oval shape, or a polygonal shape. According to one or more embodiments, the bottom surface on which the discharge port is disposed may have a circular shape, an oval shape, or a polygonal shape. The shape of the discharge port and the shape of the bottom surface of the nozzle may be selected independently of each other. The shapes of the discharge port and the bottom surface may be identical to or different from each other.

In some embodiments, the 3D printing material may include at least one selected from a thermoplastic polymer, a metal, a composite material, and a bio-friendly material.

In this regard, the thermoplastic polymer may be selected from polylactic acid (PLA), acrylonitrile-butadiene-styrene (ABS) resin, nylon, and polyvinyl alcohol. When PLA is applied as the 3D printing material, it is suitable for the environment-friendly trend in recent technological development, since PLA is an environment-friendly resin and does not contain any harmful constituents, and further, PLA may undergo less shrinkage and less generation of bubbles than other materials, which may facilitate production. However, the 3D printing material is not limited to PLA. For example, the 3D printing material may include a metal, e.g., aluminum, platinum, silver, or gold, but embodiments are not limited thereto. For example, the 3D printing material may include a composite material, e.g., an organic light-emitting material or a composite material of TiO₂ and plastic, but embodiments are not limited thereto.

In some embodiments, the 3D printing material may have a filament form, but embodiments are not limited thereto.

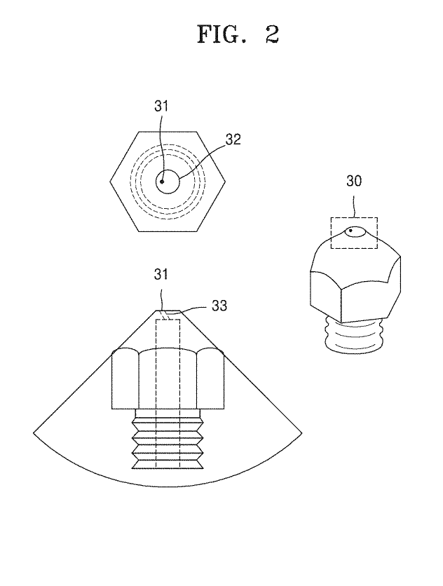

FIG. 2 is a schematic view of another embodiment of an eccentric discharge port nozzle. Hereinafter, with reference to FIGS. 1A, 1 B, and 2, a flow path in the eccentric discharge port nozzle will be described.

In some embodiments, in the nozzle 20 or a nozzle 30 for a 3D printer, the nozzle 20 or 30 may further include a flow path 23 or 33, through which a 3D printing material passes, wherein the flow path 23 or 33 may be connected to the discharge port 21 or a discharge port 31 located in the bottom surface 22 or a bottom surface 32.

For example, the flow path may have a cylindrical shape, a tub shape of which a vertical cross-section of a rotational axis may be polygonal, or a polyhedral shape, but embodiments are not limited thereto.

In some embodiments, the flow path may be connected to the discharge port in a direction perpendicular to the bottom surface. In this regard, with reference to FIG. 1 B, the flow path 23 included in the nozzle 20 may be connected to the discharge port 21 in a direction perpendicular to the bottom surface 22 (i.e., Y direction).

In some embodiments, the flow path may be connected to the discharge port in a direction that is not perpendicular to the bottom surface. In this regard, with reference to FIG. 2, the flow path 33 included in the nozzle 30 may be connected to the discharge port 31 in a direction that is not perpendicular to the bottom surface 32.

In some embodiments, the flow path may include at least one bent portion, or may not include a bent portion. When the flow path includes at least one bent portion, variables, such as the position of the bent portion, curvature, and the number of bent portions, may be controlled to obtain a desired level of a strain rate of the output.

According to another aspect of the present disclosure, a 3D printer may include at least one nozzle unit including the nozzle described above; a nozzle-shifting unit configured to shift the at least one nozzle unit in all directions; and an output area under the at least one nozzle unit, on which the 3D printing material extruded from the nozzle may be stacked, and an output may be formed.

For example, the 3D printer may include one nozzle unit. For example, the 3D printer may include at least two nozzle units.

According to one or more embodiments, a speed ratio (Vₜ/Vₚ) of a feeding speed (Vₜ) over a printing speed (Vₚ) may be in a range of about 0.1 to about 10, wherein Vₚ may be a speed required for forming the output, and Vₜ may be a speed at which the 3D printing material is discharged from the nozzle. For example, Vₜ/Vₚ may be in a range of about 1.0 to about 2.0, but embodiments are not limited thereto.

In the case of a centric discharge port nozzle of the related art, unless a particular additional apparatus is included, only a linear output may be formed. On the other hand, when a 3D printer includes the eccentric discharge port nozzle as described in the present disclosure, Vₜ/Vₚ may be controlled such that an output is formed in a desired shape.

According to one or more embodiments, the output formed on the output area may include at least one curled area.

According to one or more embodiments, the output formed on the output area may include at least one pattern selected from a straight pattern, a wavy pattern, an alternating pattern, a coiling pattern, an overlapping pattern, and a braided pattern.

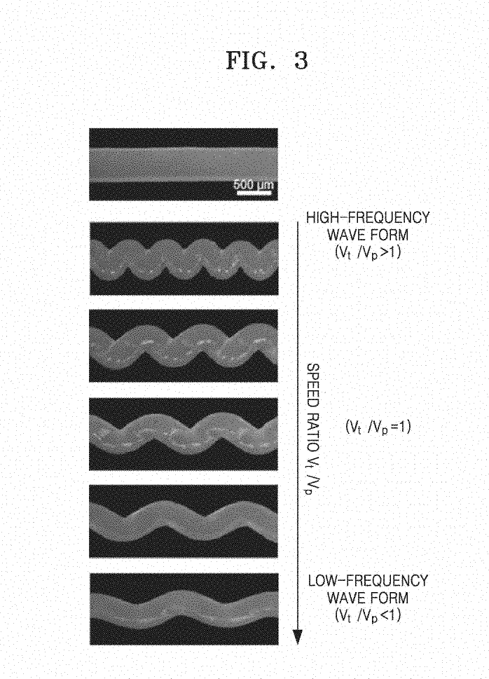

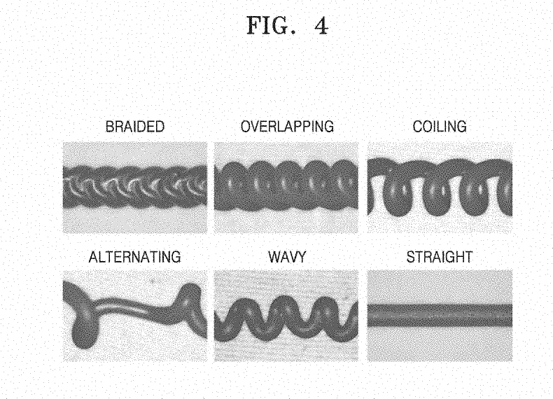

FIG. 3 shows images of meandering outputs formed by using an eccentric discharge port nozzle according to one or more embodiments, according to a speed ratio Vₜ/Vₚ, the outputs being different from a linear output formed by using a centric discharge port nozzle of the related art. FIG. 4 shows images of various patterns that may be included in outputs formed by using an eccentric discharge port nozzle according to one or more embodiments by controlling process parameters. Referring to FIG. 3, as Vₜ/Vₚ increases, the form of the output changes from a low frequency wave form to a high frequency wave form.

In particular, by controlling Vₜ/Vₚ, various shapes of meandering patterns may be formed. Examples thereof are as follows (the shapes of each pattern are shown in FIG. 4):

a) when Vₜ/Vₚ=1.0, a wavy pattern may be formed;

b) when 1.0<Vₜ/V_{p≤}1.4, an alternating pattern or a coiling pattern may be formed;

c) when 1.4<Vₜ/Vₚ1.6, an alternating pattern, a coiling pattern, or an overlapping pattern may be formed; and

d) when 1.6<Vₜ/Vₚ2.0, a coiling pattern, an overlapping pattern, or a braided pattern may be formed.

However, the above patterns are provided as examples only, and the shape of each pattern is not limited as described above according to the range of Vₜ/Vₚ.

When Vₜ/Vₚ, i.e., a speed ratio is high, the amount of the 3D printing material that is discharged may be excessive with respect to the printing speed. Thus, when the 3D printing material touches a surface, e.g., an output area on which the output is formed, the 3D printing material may be in a state of buckling instability. Accordingly, due to longitudinal compressive stress, a curled area having a curled form is formed. As Vₚ decreases, the difference between Vₚ and Vₜ may increase, and a greater amount of the 3D printing material may accumulate within the same printing distance. Thus, the frequency as well as the degree of meandering may further increase, which may result in a change of form from a wavy pattern to an overlapping pattern.

According to one or more embodiments, the output formed on the output area may have a multilayer structure formed by stacking at least two layers of the 3D printing material.

For example, the multilayer structure may be i) a structure in which a layer including at least one curled area may be stacked, or ii) a structure in which a layer including at least one curled area and a layer not including a curled area may be stacked in a random sequence.

In this regard, the layer including at least one curled area may include, for example, a wavy pattern, an alternating pattern, a coiling pattern, an overlapping pattern, or a braided pattern, but embodiments are not limited thereto. Further, the layer not including a curled area may include a straight pattern, but embodiments are not limited thereto.

For example, the multilayer structure may include a combination of various patterns including the straight pattern, the wavy pattern, the alternating pattern, the coiling pattern, the overlapping pattern, and the braided pattern. As described above, when an output having a multilayer structure is output through the eccentric discharge port nozzle, a strain rate of the output may be significantly improved compared to a centric discharge port nozzle of the related art.

In some embodiments, the output area may include a substrate including at least one material selected from paper, wood, metal, and polymer.

The 3D printer may further include a driving unit for displacing the output area in a vertical direction.

In some embodiments, a vertical length of the driving unit may be variable such that the position of the output area may be variable in a vertical direction.

In some embodiments, fused filament fabrication (FFF), fused deposition modeling (FDM), or material extrusion(ME) may be used by the 3D printer.

According to still another aspect of the present disclosure, a 3D printer for four-dimensional (4D) printing technology may include a first nozzle unit and a second nozzle unit, each including a nozzle for a 3D printer; a nozzle-shifting unit configured to shift the first nozzle unit and the second nozzle unit in all directions; and an output area under the first nozzle unit and the second nozzle unit and on which a 3D printing material discharged from each of the nozzles of the first nozzle unit and the second nozzle unit is stacked, respectively, and an output is formed, wherein at least one of the first nozzle unit and the second nozzle unit may include the nozzle described above.

That is, as described above, when a nozzle unit including a nozzle including the eccentric discharge port and an additional nozzle unit are included, the 3D printing materials discharged from each of the two nozzle units may be stacked in a sequence to form a desired output, thereby establishing a 3D printer for 4D printing technology.

According to one or more embodiments, i) at least one of the first nozzle unit and the second nozzle unit may include a centric discharge port, or ii) the first nozzle unit and the second nozzle unit may each include an eccentric discharge port. For example, the first nozzle unit may include a centric discharge port, and the second nozzle unit may include an eccentric discharge port. For example, the first nozzle unit may include an eccentric discharge port, and the second nozzle unit may include a centric discharge port. For example, the first nozzle unit and the second nozzle unit may each include an eccentric discharge port. For example, the first nozzle unit and the second nozzle unit may each be on a plane parallel with the output area. For example, the first nozzle unit and the second nozzle unit may each be on a plane that is not parallel with the output area.

Here, other than the nozzle for a 3D printer, structures of a 3D printer or a 3D printer for 4D printing technology and methods of manufacturing a 3D printer or a 3D printer for 4D printing technology are known in the art. Therefore, detailed descriptions thereof are omitted herein.

Hereinafter, the effects of the present disclosure will be described in detail through experimental examples.

### Experimental Example 1

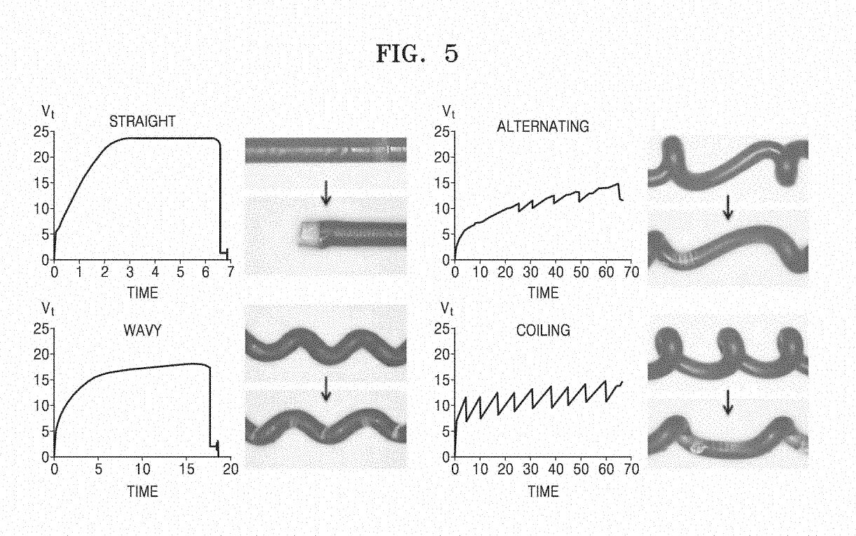

Tension samples were prepared by forming outputs under the same conditions except that a centric discharge port nozzle of the related art or an eccentric discharge port nozzle was used to form the outputs. Then, a tensile strength test was performed on each tension sample. The deformation results of the tensile strength test are shown in FIG. 5 as graphs.

Referring to FIG. 5, in the case of the tension sample prepared by using the eccentric discharge port nozzle, a speed ratio may be controlled by fixing Vₚ and by varying Vₜ among preparation process parameters to prepare patterns of various shapes, unlike the tension sample prepared by using the centric discharge port nozzle. In particular, as compared with the straight pattern, the coiling pattern may exhibit about 10 times or more deformation.

### Experimental Example 2

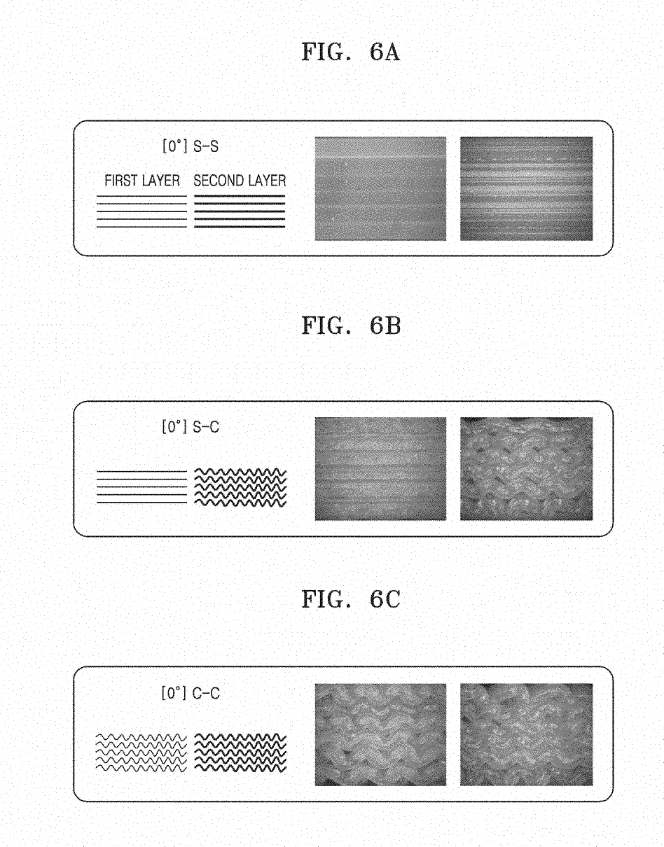

A multilayer structure in which two linear layers were stacked by using a centric discharge port nozzle of the related art (hereinafter referred to as an S-S structure (hereinafter ‘S’ indicates ‘straight’)); a structure in which a first layer was stacked by using a centric discharge port nozzle, and a second layer was stacked by using an eccentric discharge port nozzle (hereinafter referred to as an S-C structure (hereinafter ‘C’ indicates ‘curled’)); and a structure in which two layers were stacked by using an eccentric discharge port (hereinafter referred to as a C-C structure) were output. The cross-sections of the outputs of the S-S structure, the S-C structure, and the C-C structure are shown in FIGS. 6A, 6B, and 6C. In particular, FIG. 6A illustrates the S-S structure, FIG. 6B illustrates the S-C structure, and FIG. 6C illustrates the C-C structure.

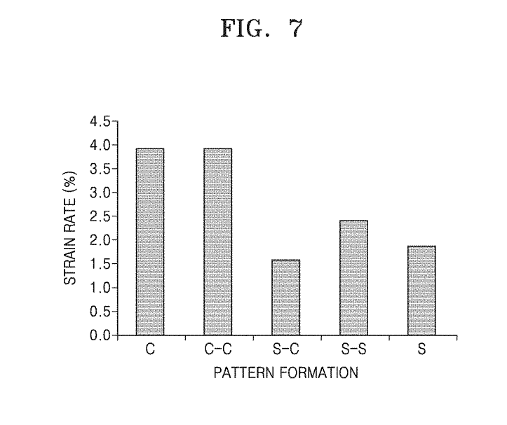

In addition to the outputs, the tensile strength test was performed on an output of a monolayer structure formed by using a centric discharge port nozzle (hereinafter, referred to as an S structure) and an output of a monolayer structure formed by using an eccentric discharge port nozzle (hereinafter, referred to as a C structure). In the tensile strength test, the strain rates of the outputs were measured, and the results thereof are shown in the graph of FIG. 7.

Referring to FIG. 7, among the outputs formed by using the centric discharge port nozzle, the S structure has a strain rate of 1.87%, and the S-S structure has a strain rate of 2.42%. However, among the outputs formed by using the eccentric discharge port nozzle, the C structure has a strain rate of 3.92%, and the C-C structure has a strain rate of 3.94%. In other words, in the case of the outputs formed by using the eccentric discharge port nozzle, the monolayer structure and the multilayer structure each were found to have a high strain rate, as compared with the outputs formed by using the centric discharge port nozzle.

In particular, the S-C structure was found to have a strain rate of 1.58%, which is even lower than the S structure or the S-S structure.

### Experimental Example 3

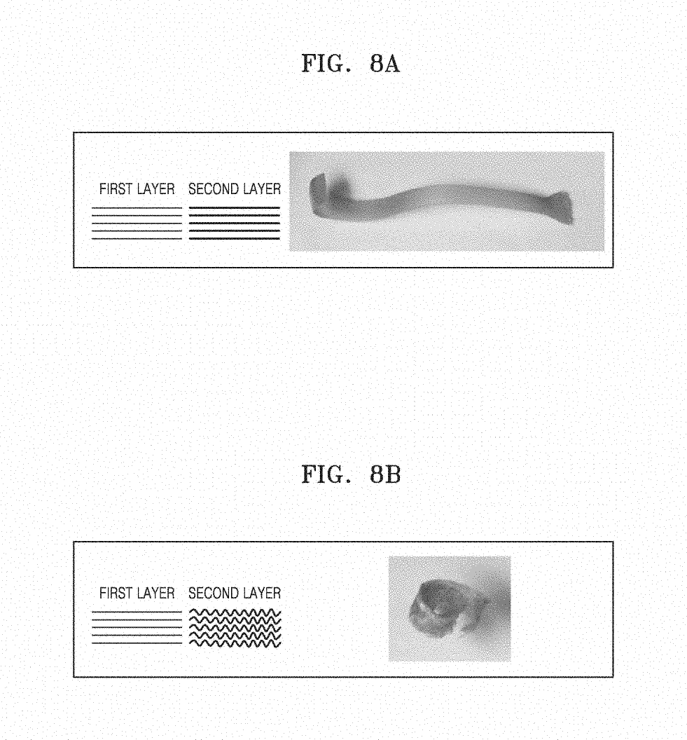

So that an output after being stacked may respond to heat, PLA, which is a thermoplastic material, was used as a 3D printing material to prepare outputs. Using the characteristics of the thermoplastic material, outputs were stretched twice longer at temperatures above the glass transition temperature of PLA. The deformed shape was then fixed at a temperature under the glass transition temperature of PLA. Thereafter, the deformed shape may tend to revert to its original shape once the deformed shape is exposed to a temperature above the glass transition temperature. Here, depending on the characteristics of the material or the structure, different deformation may be induced. FIGS. 8A and 8B show the results of effects of a meandering pattern prepared using an eccentric discharge port nozzle by utilizing the above-described characteristics. FIG. 8A shows images of the results of deformation behavior of the outputs of S-S structure which were implemented by using a centric discharge port nozzle according to the related art, and FIG. 8B shows images of the results of deformation behavior of the outputs of S-C structure which were implemented by using an eccentric discharge port nozzle according to an embodiment. As shown in FIG. 8A, in the case of the S-S structure in which the first and second layers had the same pattern, when the temperature was changed from 100 ° C. to 25 ° C., little change occurred because the relative deformation behaviors were the same. However, in the case of the S-C structure as shown in FIG. 8B, due to the difference between the strain rate of the straight line and that of the meandering line, the C line was deformed to a greater degree, and thus curled to have the form of an S.

### Experimental Example 4

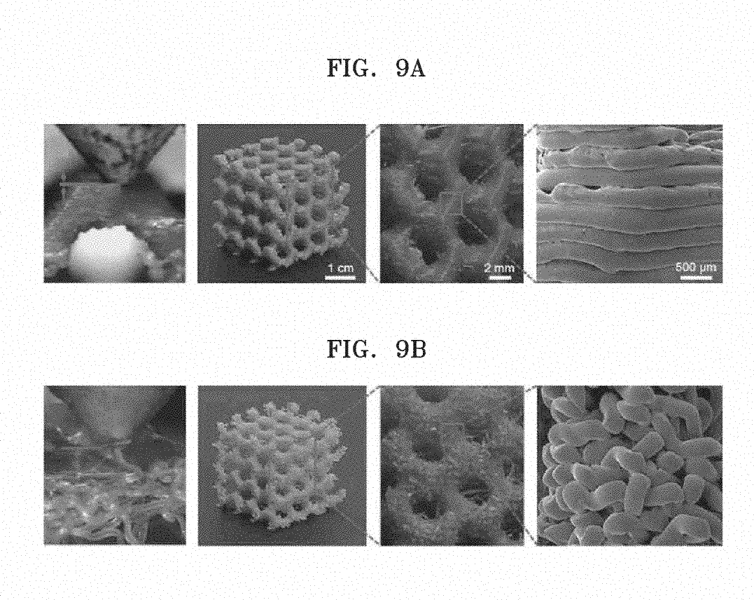

3D structures were prepared by forming outputs under the same condition except that a centric discharge port nozzle of the related art or an eccentric discharge port nozzle was used to form the outputs. The images of the 3D structures are shown in FIGS. 9A and 9B. In particular, FIG. 9A is an image of a 3D structure output by using a centric discharge port nozzle of the related art. FIG. 9B is an image of a 3D structure output by using an eccentric discharge port nozzle.

Referring to FIG. 9A, in the case of the 3D structure output by using the centric discharge port nozzle of the related art, upon being output, the printing material is stacked such that a gap is input between layers. Thus, the 3D structure has a relatively uniform surface shape and a relatively small surface area.

On the other hand, referring to FIG. 9B, in the case of the 3D structure output by using the eccentric discharge port nozzle according to an embodiment, the output has a meandering shape. Thus, the output has a relatively large surface area, as compared with the centric discharge port nozzle of the related art.

As the nozzle for a 3D printer and a 3D printer including the nozzle include a discharge port eccentrically located with respect to the center of the nozzle, upon stacking an output, the surface area of the output may be enlarged and a strain rate of the output may be increased if the output is formed in lines of various curved shapes other than a straight line. Accordingly, an output having a structure with excellent physical properties beyond the deformation limit of a 3D printing material may be realized. In particular, in the existing material extrusion (ME) system, hardware may be configured by changing a nozzle structure only. Further, by controlling a position of a nozzle discharge port and stacking conditions such as speed ratio, a surface area of an output may be increased, and the deformation limit may be improved.

As apparent from the foregoing description, when the nozzle according to the present disclosure is used, by changing a nozzle only, a 3D printer may have a significantly increased strain rate of an output, as compared with 3D printers of the related art. Also, it is possible to produce an output having a more complex and creative structure while maintaining the same level of production speed as 3D printers of the related art, thereby allowing production of a 3D curved surface having a large surface area.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the disclosure as defined by the following claims.

What is claimed is:

1. A nozzle for a three-dimensional (3D) printer to extrude a 3D printing material, the nozzle comprising: a discharge port in a bottom surface of the nozzle and configured to extrude the 3D printing material, the discharge port being eccentrically located with respect to a center of the bottom surface.

2. The nozzle of claim 1, wherein the discharge port is located within a radius in a range of about 1 micrometer (μm) to about 100 centimeters (cm) from the center of the bottom surface.

3. The nozzle of claim 1, wherein a diameter of the discharge port is in a range of about 10 percent (%) to about 30% of a diameter of the nozzle.

4. The nozzle of claim 1, wherein the discharge port has a circular shape, an oval shape, or a polygonal shape.

5. The nozzle of claim 1, wherein the bottom surface has a circular shape, an oval shape, or a polygonal shape.

6. The nozzle of claim 1, further comprising a flow path through which the 3D printing material passes, wherein the flow path is connected to the discharge port located in the bottom surface.

7. The nozzle of claim 6, wherein the flow path has a cylindrical shape; a tub shape of which a vertical cross-section of a rotational axis is polygonal; or a polyhedral shape.

8. The nozzle of claim 6, wherein the flow path is connected to the discharge port in a direction perpendicular to the bottom surface.

9. The nozzle of claim 6, wherein the flow path is connected to the discharge port in a direction that is not perpendicular to the bottom surface.

10. The nozzle of claim 6, wherein the flow path comprises at least one bent portion, or does not comprise a bent portion.

11. A 3D printer comprising:
at least one nozzle unit comprising the nozzle of claim 1;
a nozzle-shifting unit configured to shift the at least one nozzle unit in all directions; and
an output area under the at least one nozzle unit and on which the 3D printing material extruded from the nozzle is stacked and an output is formed.

12. The 3D printer of claim 11, wherein a speed ratio (Vₜ/Vₚ) of a feeding speed (Vₜ) over a printing speed (Vₚ) is in a range of about 0.1 to about 10, wherein Vₚ is a speed required for forming the output, and Vₜ is a speed at which the 3D printing material is extruded from the nozzle.

13. The 3D printer of claim 11, wherein the output formed on the output area comprises at least one curled area.

14. The 3D printer of claim 11, wherein the output formed on the output area comprises at least one pattern selected from a straight pattern, a wavy pattern, an alternating pattern, a coiling pattern, an overlapping pattern, and a braided pattern.

15. The 3D printer of claim 11, wherein the output formed on the output area has a multilayer structure formed by stacking at least two layers of the 3D printing material.

16. The 3D printer of claim 15, wherein the multilayer structure is:
i) a structure in which a layer comprising at least one curled area is stacked, or
ii) a structure in which a layer comprising at least one curled area and a layer not comprising a curled area are stacked in a random sequence.

17. The 3D printer of claim 11, the 3D printer further comprising a driving unit for displacing the output area vertically.

18. The 3D printer of claim 11, wherein the 3D printer uses fused filament fabrication (FFF), fused deposition modeling (FDM), or material extrusion(ME).

19. A 3D printer for four-dimensional (4D) printing technology comprising:
a first nozzle unit and a second nozzle unit, each comprising a nozzle for a 3D printer;
a nozzle-shifting unit configured to shift the first nozzle unit and the second nozzle unit in all directions; and
an output area under the first nozzle unit and the second nozzle unit and on which a 3D printing material extruded from each of the nozzles of the first nozzle unit and the second nozzle unit is stacked, respectively, and an output is formed, wherein at least one of the first nozzle unit and the second nozzle unit comprises the nozzle of claim 1.

20. The 3D printer for 4D printing technology of claim 19, wherein i) at least one of the first nozzle unit and the second nozzle unit further comprises a centric discharge port, or ii) the first nozzle unit and the second nozzle unit each further comprise an eccentric discharge port.
